(19) United States
(12) Patent Application Publication
(10) Pub. No.: US 2016/0041819 A1
(43) Pub. Date: Feb. 11, 2016

(54) UPDATING SERVICE APPLICATIONS

(71) Applicant: Microsoft Corporation, Redmond, WA (US)

(72) Inventors: Ravi Raju Mantena, Seattle, WA (US); Thayalan Pirapakaran, Bellevue, WA (US); Saurin Bipin Shah, Kirkland, WA (US); Parna Khot, Kirkland, WA (US); Kshamta Jerath, Bothell, WA (US); Daniel J. Cole, Sammamish, WA (US)

(21) Appl. No.: 14/452,994

(22) Filed: Aug. 6, 2014

(51) Int. Cl. G06F 9/445; H04L 29/08

(52) U.S. Cl. CPC G06F 8/65; H04L 67/10

(57) ABSTRACT

Disclosed herein are systems, methods, and software for enhancing application update processes. In an implementation, a delta file is received in a data center that hosts various instances of a service application. The delta file represents a difference between a new version of the service application and a previous version of the service application. An instance of the service application installed in the data center is removed from service temporarily in order to update it from the previous version of the service application to the new version of the service application. Upon initiating and completing an update of the instance of the service application to the new version of the service application using at least the delta file, the instance is returned to service.

### TECHNICAL FIELD

Aspects of the disclosure are related to computing hardware and software technology, and in particular, to updating service applications in data centers.

### TECHNICAL BACKGROUND

Software applications are frequently updated when patches, new versions, or other changes are available for a given product. Application updates have been accomplished in the past by downloading and installing a new application package, which can consume a great deal of time and bandwidth due to the size of a file or files in the package. A technique was developed to overcome this limitation that utilized delta files to update applications. A delta file represents the difference between two files and can be shipped as part of an update to reduce network load and installation time.

Updating applications that are installed in data centers presents various challenges due to the nature of the cloud services that are often times deployed in such service environments. For one, many services that are deployed at-scale utilize a large number of application instances and service platforms. Examples of such services include email, document productivity, document storage, communication, and gaming services. Moving the files needed to update all of the instances can place a huge strain on the infrastructure that supports the service. Coordinating updates across large numbers of application instances can also be problematic, especially in the case of always-on services.

In a brief example of one such service, client applications run on end-user devices that provide a user interface to the service, which may be hosted in a data center or in some other suitable computing facility. Multiple instances of a service application or applications execute on service platforms in the data center to provide the service over networking links to the local applications. End users may experience the service via their personal computer, tablet, smart phone, wearable device, or the like.

When a patch, a new version, or some other update to a service application is available, a new build is typically commissioned for each instance of the service application that is deployed in a service environment, such as a data center. The update file or files are uploaded from a development environment to the machine in the service environment on which it is to be installed. Once the files are installed, the existing instance of the application is taken out of service and the new instance of the application is put into service. This process may progress incrementally until all of the instances of an application are updated.

### OVERVIEW

Provided herein are systems, methods, and software to enhance service application updates. Delta files may be produced when a new version, patch, or other such change to a service application is created in a development environment. Instances of the service application installed and running in service environments may be updated using the delta file or files, rather than having to produce entirely new builds for the application.

In at least one implementation, a delta file is received in a data center that hosts various instances of a service application. The delta file represents a difference between a new version of the service application and a previous version of the service application. An instance of the service application installed in the data center is removed from service temporarily in order to update it from the previous version of the service application to the new version of the service application. Upon initiating and completing an update of the instance of the service application to the new version of the service application using at least the delta file, the instance is returned to service.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational architecture in an implementation in which instances of a service application are updated.

FIG. 2 illustrates an update process that may be employed in a service environment to update instances of a service application.

FIG. 3 illustrates an operational scenario in an implementation.

FIG. 4 illustrates an operational architecture in an implementation in which instances of a service application are updated.

FIG. 5 illustrates an operational scenario in an implementation.

FIG. 6 illustrates an operational scenario in an implementation.

FIG. 7 illustrates a computing system suitable for implementing any of the applications, services, processes, architectures, and operational scenarios disclosed herein with respect to FIGS. 1-6 and discussed below in the Technical Disclosure.

### TECHNICAL DISCLOSURE

Implementations disclosed herein enhance the provisioning and delivery of service application updates. In at least one implementation, a new version of a service application is created in a development environment. A delta file may be produced that represents a difference between the new version and a previous version installed in a data center or other suitable service environment. The delta file may be communicated to the data center to allow instances of the service application to be updated or upgraded to the new version of the application.

In some implementations, each instance of the service application includes or is associated with an update agent that periodically checks for available updates. This may include the update agent communicating with the development environment and downloading a delta file when one becomes available. The delta file may thus be retrieved and provided on a per-instance basis. An update agent may be provided for each instance of a service application or for groups of application instances.

In other implementations, a delta file may be communicated from a development environment to a service environment for staging in a storage service in the service environment. The delta file may then be distributed to various service platforms or update agents for updating their corresponding instances of the service application.

Updating service applications with delta files may provide various technical effects that improve the provisioning and delivery of online services. In the case of large-scale online services, bandwidth may be conserved when uploading a delta file or files to a service environment that might otherwise be consumed if full versions of the file or files involved in an update had to be uploaded. In addition, storage space may be conserved in a service environment due to the reduced size of a delta file relative to a full version of a file. This may allow multiple delta files for multiple application states to be stored on a storage environment, thereby enabling the state of an application to be transitioned backward or forward depending upon operating circumstances.

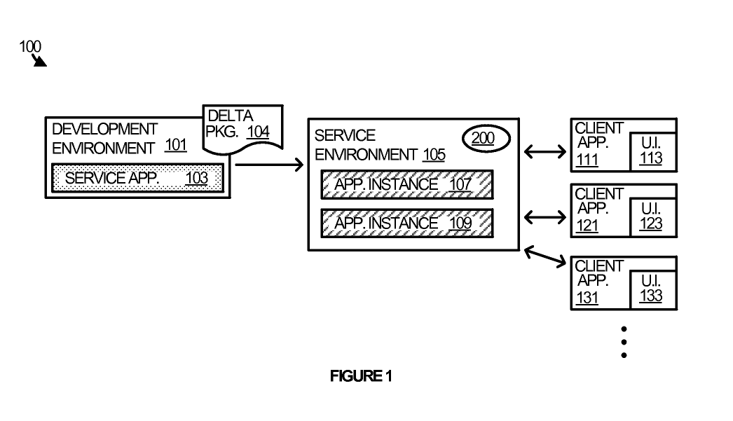

Referring to the drawings, FIG. 1 illustrates operational architecture 100 in an implementation. Operational architecture 100 includes development environment 101 in which service applications may be developed. Service application 103 is representative one such service application. Delta package 104 is produced in development environment 101 and represents a difference between a new version of service application 103 and a previous version of service application 103 installed in a service environment.

Operational architecture 100 also includes service environment 105, which is representative of any environment in which instances of service application 103 may be installed an operated. Application instance 107 and application instance 109 are representative of instances of service application 103. Application instance 107 and application instance 109 communicate over a network or networks with client applications to provide a service to end-users, such as email, productivity, communication, media, storage, or gaming services, as well as any other type of online service.

Client application 111, client application 121, and client application 131 are each representative of any client application that may be suitable for communicating with service environment 105 and its various elements. Client application 111, client application 121, and client application 131 present, render, or otherwise present user interfaces to the service through which users may interact with the service. User interface 113, user interface 123, and user interface 133 are each representative of such user interfaces.

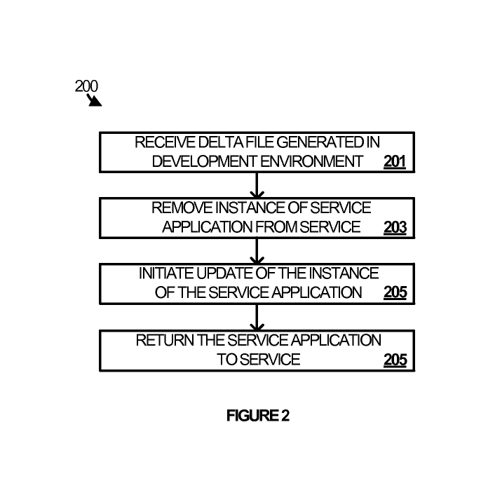

Service environment 105 employs an update process 200 to update instances of service applications installed therein. Update process 200 is representative of any process, module, program, or collection thereof that may be executed by a suitable computing system to update service application instances, of which computing system 701 is representative. When executed, update process 200 may provide various capabilities or functionality represented by the steps illustrated in FIG. 2. The following operational discussion therefore makes reference parenthetically to the steps in FIG. 2. Other functionality in addition to the steps disclosed herein are possible and may be considered within the scope of the present disclosure.

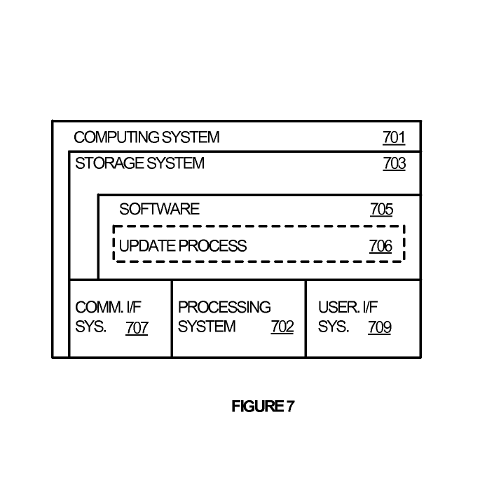

In operation, developers may engage in developing a new version of service application 103. The new version may be a partially new version, an entirely new version, a patch, or some other modification that necessitates updating installed instances of service application 103. The new version of service application 103 could be developed using a suitable computing system, of which computing system 701 in FIG. 7 is representative, as well as suitable development tools, including a tool for generating delta files.

Service application 103 may include one or more files that are typically installed on given service platform in order to instantiate an instance of the application. Delta package 104 may thus be produced that includes at least one delta file representative of a difference between at least one of the files associated with the new version of service application 103 and at least one of the files associated with a previous version of service application 103. In some scenarios delta package 104 may include multiple files. In yet other scenarios, delta package 104 may be a single delta file. Other variations and combinations of delta packages and files are possible.

When delta package 104 is ready, it may be communicated over a network or networks to service environment 105. Update process 200 receives delta package 104 or is otherwise notified that it has been uploaded to service environment 105 (step 201). In some cases delta package 104 may be uploaded on a per-application instance basis, while in other cases a single copy of delta package 104 may be uploaded to service environment 105 for distribution to and installation on the various service platforms that may support application instance 107 and application instance 109. Other mechanisms and methods for providing delta package 104 are possible and may be within the scope of the present disclosure.

Update process 200 proceeds to update various instances of service application 103 that are installed in service environment 105. The instances may be updated iteratively, one after another, in parallel, or in some other order. For each instance of service application 103 that is updated, update process 200 first removes the instance from service (step 203).

The update to the removed instance is then initiated (step 205) and may proceed in accordance with any of a variety of techniques for updating applications with delta files. Update process 200 itself may perform the update or the task of updating a target application instance may be handed off to another element or elements in service environment 105. Once a given application instance has been updated, the application instance may be returned to service (step 205).

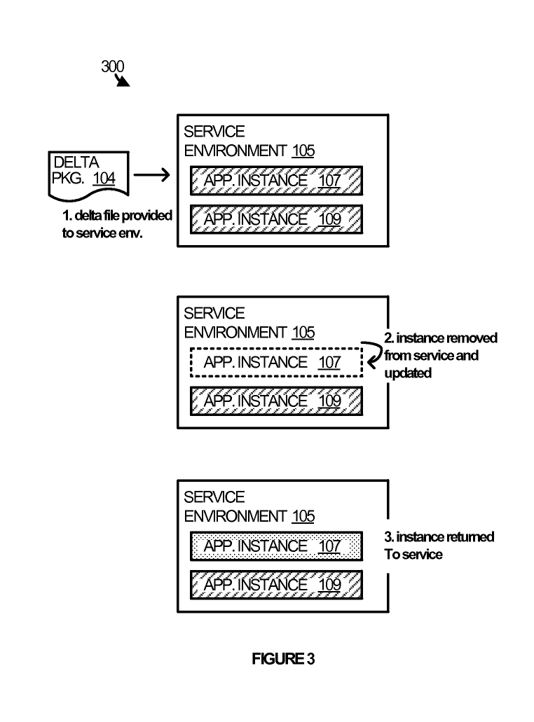

FIG. 3 illustrates an operational scenario 300 that provides a specific example of how a service application may be updated in an example. In operation, delta package 104 is provided to service environment 105. As mentioned, delta package 104 may be communicated on a direct, per-instance basis or may be delivered once, for general distribution to the various service platforms that may host application instances.

In this example, application instance 107 is selected first for updating. Application instance 107 is taken out of service so that client applications cannot communicate with it while it is being updated. Application instance 107 is updated with the delta file or delta files included in delta package 104. Once application instance 107 is updated, it may be returned to service. It may be appreciated that the shading used in FIG. 3 with respect to application instance 107 represents its transition from a previous version of service application 103 to the new version of service application 103 created in development environment 101.

Using delta package 104 to update application instance 107 may reduce the bandwidth that may otherwise be consumed between development environment 101 and service environment 105 when uploading installation files. In addition, storage space may be conserved in service environment 105 as delta files utilize less space than full files.

Referring back to FIG. 1, development environment 101 is representative of any computing environment in which service application 103 may be developed. Development environment 101 may be software, hardware, or a combination thereof. Examples of computing hardware that may be used to facilitate development environment 101 include, but are not limited to, desktop computers, laptop computers, tablet computers, server computers, Internet appliances, and virtual machines, as well as any variation or combination thereof, of which computing system 701 illustrated in FIG. 7 is representative.

Service application 103 is representative of any application that may be developed in development environment 101 for installation in service environment 105. Instances of service application 103 function in service environment 105 to provide a service to end users. Examples of such services include, but are not limited to, email, document productivity, media, gaming, communications, e-commerce services, entertainment, storage, and enterprise services. Instances of service application 103, such as application instance 107 and application instance 109, may be hosted in any suitable service environment, of which service environment 105 is representative.

Service environment 105 is representative of any computing software, hardware, or combination thereof capable of hosting application instances 107 and 109. Service environment 105 may be a stand-alone environment or may be integrated with other environments. In some instances, service environment 105 may be a data center. Service environment 105 may be implemented using a computing system or systems, of which computing system 701 in FIG. 7 is representative. Examples of application services that may be provided by service environment 105 include, but are not limited to, Office365® from Microsoft® and Google® Docs, as well as any other suitable application service, combination of services, or variations thereof.

Client applications 111, 121, and 131 are each representative of any software application, module, component, or collection thereof, capable of implementing user interfaces to a service, of which user interfaces 113, 123, and 133 are exemplary. Examples include, but are not limited to, word processing applications, spreadsheet applications, presentation applications, web browsers, blogging and micro-blogging applications, social networking applications, and e-commerce applications, as well as any other type of suitable application. Each client application may be a browser-based application that executes in the context of a browser application. In some implementations, the client application may execute in the context of or in association with a web page, web site, web service, or the like. However, the client application may also be a locally installed and executed application, a streamed application, a mobile application, or any combination or variation thereof. Each client application may be implemented as a stand-alone application or may be distributed across multiple applications.

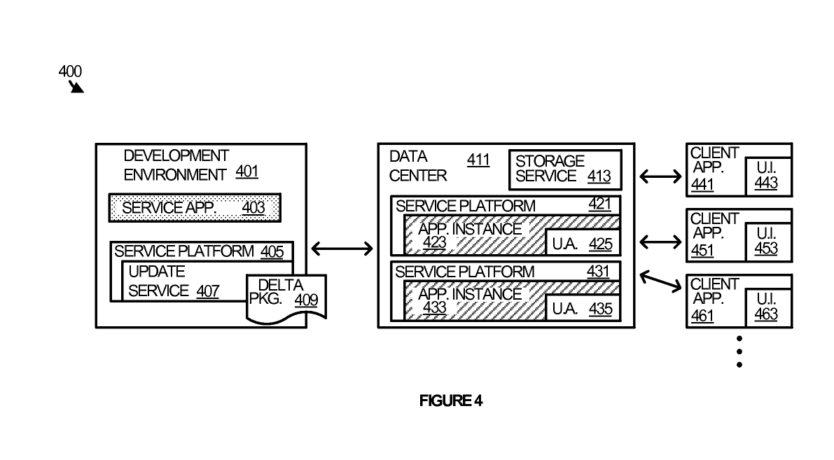

FIG. 4 illustrates operational architecture 400 in an implementation. Operational architecture 400 includes development environment 401 in which a service application may be developed. Service application 403 is representative of one such application. Development environment 401 also includes service platform 405 that hosts an update service 407. Update service 407 is used to generate a delta package 409 for updating installed instances of service application 403. Delta package 409 may include a single delta file or multiple delta files, each of which may represent at least a difference between at least one file included a newly developed version of service application 403 and previous versions.

Operational architecture 400 also includes data center 411. Various service platforms reside in data center 411 and are employed to deliver a service or services to client applications engaged remotely with instances of service application 403 hosted on the service platforms. Service platform 421 hosts application instance 423 and service platform 431 hosts application instance 433. Client application 441, client application 451, and client application 461 are representative of client applications capable of communicating with service applications in data center 411 in order to provide a service to users. The users may experience various features, functionality, and other aspects of the service via user interface 443, user interface 453, and user interface 463 rendered by client application 441, client application 451, and client application 461 respectively.

Application instance 423 includes update agent 425 and application instance 433 includes update agent 435. Update agents 425 and 435 may function to monitor for new delta packages available in development environment 401 or uploaded to storage service 413. Storage service 413 is optional and may be eliminated in some example or utilized in a different manner than described herein. Storage service 413 is representative of any service capable of storing delta packages for distribution to service platforms that use the delta packages for updating application instances.

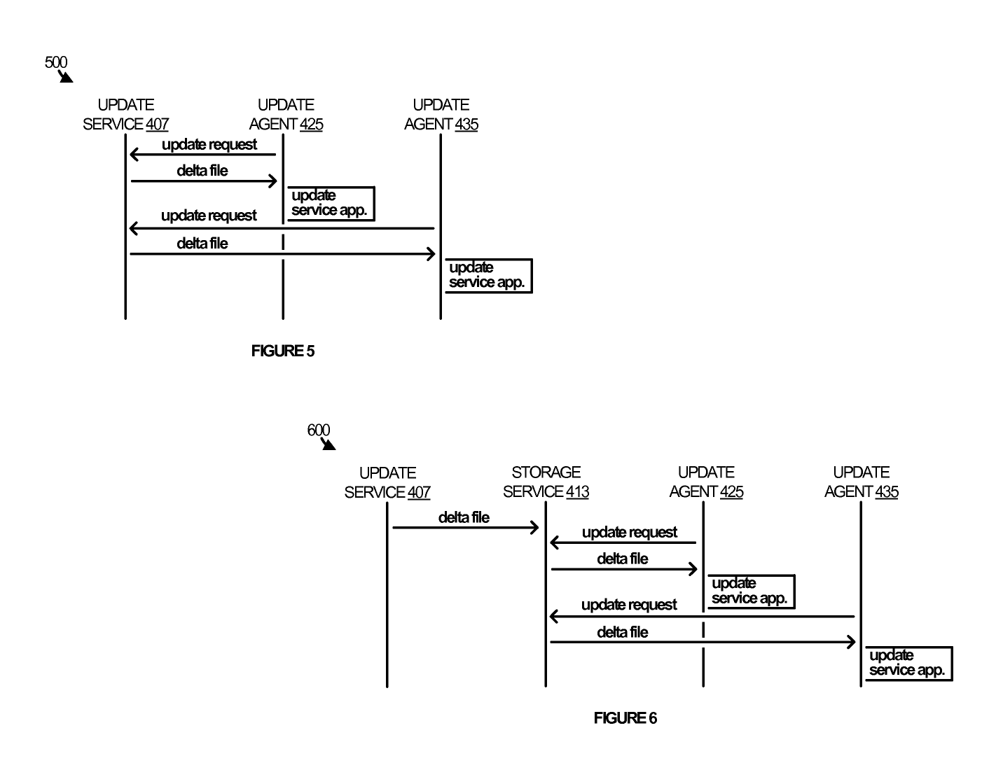

FIG. 5 illustrates an exemplary operational scenario 500 that illustrates one way in which application instances 423 and 433 may be updated. In operation, update service 407 produces delta package 409 and makes delta package 409 available to data center 411. This may include, for example, communicating notifications to update agents 425 and 435 that an update is available or responding to queries from update agents 425 and 435 inquiring about the status of any updates.

In this example, each update agent makes a separate, individual request for delta package 409. First update agent 425 requests delta package 409, in response to which update service 407 uploads the package to data center 411. This may include uploading delta package 409 directly to service platform 421. However, delta package 409 could be uploaded to storage service 413 in response to the request and then, in turn, downloaded to service platform 421. Regardless, user agent 425 takes application instance 423 out of service and updates it using the delta file or files included in delta package 409. Once the update is complete, user agent 425 returns application instance 423 to service.

Either in series or in parallel with updating application instance 423, user agent 435 requests delta package 409 from update service 407. Update service 407 responsively uploads delta package 409 to data center 411. As mentioned, delta package 409 may be uploaded directly to service platform 431 or may be uploaded to storage service 413, or some other intermediate location, and then downloaded to service platform 431. User agent 435 takes application instance 433 out of service temporarily and initiates an update process to update application instance 433 to the new version of service application 403. Having updated application instance 433, it can be returned to service.

FIG. 6 illustrates another exemplary operational scenario 600 that illustrates another way in which application instances 423 and 433 may be updated. In operation, update service 407 produces delta package 409 and makes delta package 409 available to data center 411. This may include uploading delta package 409 to storage service 413. In some scenarios, this may also include communicating notifications to update agents 425 and 435 that an update is available or responding to queries from update agents 425 and 435 inquiring about the status of any updates.

In this example, each update agent makes a separate, individual request for delta package 409 from storage service 413. First update agent 425 requests delta package 409, in response to which delta package 409 is downloaded from storage service 413 to service platform 421. User agent 425 takes application instance 423 out of service and updates it to the new version of service application 403 using the delta file or files included in delta package 409. Once the update is complete, user agent 425 returns application instance 423 to service.

Either in series or in parallel with updating application instance 423, user agent 435 requests delta package 409 from storage service 413. Storage service 413 responsively downloads delta package 409 to service platform 431. User agent 435 takes application instance 433 out of service temporarily and initiates an update process to update application instance 433 to the new version of service application 403. Having updated application instance 433, it can be returned to service.

Referring back to FIG. 4, service platform 405 is representative of any physical or virtual computing system, device, or collection thereof capable of hosting update service 407. Examples include, but are not limited to, server computers, application servers, rack servers, blade servers, virtual machine servers, desktop computers, laptop computers, or tower servers, as well as any other type of computing system, of which computing system 701 illustrated in FIG. 7 is representative.

Service platform 421 and 431 are each representative of any physical or virtual computing system, device, or collection thereof capable of hosting all or a portion of an instance of service application 403, of which application instance 423 and 433 are representative. Examples of service platforms 421 and 431 include, but are not limited to, server computers, web servers, application servers, rack servers, blade servers, virtual machine servers, or tower servers, as well as any other type of computing system, of which computing system 701 illustrated in FIG. 7 is representative.

FIG. 7 illustrates computing system 701 that is representative of any system or collection of systems in which the various operational architectures, scenarios, and processes disclosed herein may be implemented. Examples of computing system 701 include, but are not limited to, smart phones, laptop computers, tablet computers, desktop computers, hybrid computers, gaming machines, virtual machines, smart televisions, smart watches and other wearable devices, as well as any variation or combination thereof. Other examples include server computers, rack servers, web servers, cloud computing platforms, and data center equipment, as well as any other type of physical or virtual server machine, and any variation or combination thereof.

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709. Processing system 702 is operatively coupled with storage system 703, communication interface system 707, and user interface system 709.

Processing system 702 loads and executes software 705 from storage system 703. Software 705 includes at least update process 706, which is representative of update process 200 discussed with respect to the foregoing implementations. When executed by processing system 702 to enhance document productivity, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device, but may also be distributed across multiple processing devices or sub-systems that cooperate in executing program instructions. Examples of processing system 702 include general purpose central processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device, but may also be implemented across multiple storage devices or sub-systems co-located or distributed relative to each other. Storage system 703 may comprise additional elements, such as a controller, capable of communicating with processing system 702 or possibly other systems.

Software 705 may be implemented in program instructions and among other functions may, when executed by processing system 702, direct processing system 702 to operate as described with respect to the various operational scenarios, sequences, and processes illustrated herein. For example, software 705 may include program instructions for implementing update process 200 and other associated functionality.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software or other application software, in addition to or that include update process 706. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to facilitate enhanced application updating. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Referring again to FIG. 1 as an example, through the operation of a computing system or systems of which computing system 701 is representative, transformations may be performed with respect to application instance 107. In a first stage, application instance 107 is in a state associated with a first version of service application 103. Via the operation of update process 200, delta package 104 is delivered to service environment 105 and used to upgrade application instance 107 to a new version of service application 103, thereby changing its state.

It may be understood that computing system 701 is generally intended to represent a computing system or systems on which software 705 may be deployed and executed in order to implement enhanced service application upgrades. However, computing system 701 may also be suitable as any computing system on which software 705 may be staged and from where one or both may be distributed, transported, downloaded, or otherwise provided to yet another computing system for deployment and execution, or yet additional distribution.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 709 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 709. In some cases, the input and output devices may be combined in a single device, such as a display capable of displaying images and receiving touch gestures. The aforementioned user input and output devices are well known in the art and need not be discussed at length here.

User interface system 709 may also include associated user interface software executable by processing system 702 in support of the various user input and output devices discussed above. Separately or in conjunction with each other and other hardware and software elements, the user interface software and user interface devices may support a graphical user interface, a natural user interface, or any other type of user interface.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5,XML (extensible markup language), JavaScript, JSON (JavaScript Object Notation), and AJAX (Asynchronous JavaScript and XML), as well as any other suitable protocol, variation, or combination thereof.

While FIGS. 1-6 generally depict relatively few operational scenarios and sequences, it may be appreciated that the concepts disclosed herein may be applied at scale and routinely. For example, the application service disclosed herein could be deployed in support of any number of application instances and upgrades.

Certain inventive aspects may be appreciated from the foregoing disclosure, of which the following are various examples.

### Example 1

A method for upgrading service applications deployed in data centers, the method comprising, in a data center, receiving a delta file comprising a difference between a new version of a service application and a previous version of the service application, removing an instance of the service application installed in the data center out of service temporarily to update the instance of the service application from the previous version of the service application to the new version of the service application, initiating an update of the instance of the service application to the new version of the service application using at least the delta file, and returning the instance of the service application to service upon completing the update to the new version of the service application.

### Example 2

the method according to Example 1, wherein the data center comprises a plurality of service platforms having a plurality of instances of the service application installed thereon to provide an online service to a plurality of client applications in remote communication with the plurality of instances of the service application.

### Example 3

The method according to Examples 1-2 further comprising producing the delta file in a development environment and communicating the delta file from the development environment to the data center for a plurality of update agents to update the plurality of instances of the service application.

### Example 4

The method according to Examples 1-3 wherein communicating the delta file from the development environment to the data center comprises communicating the delta file to each update agent of a plurality of update agents on an individual basis.

### Example 5

The method according to Examples 1-4 wherein communicating the delta file from the development environment to the data center comprises communicating the delta file to a staging service in the data center for distribution to each update agent of the plurality of update agents.

### Example 6

The method according to Examples 1-5 wherein the development environment comprises a plurality of development platforms for developing the new version of the service application, producing the delta file, and communicating the delta file to the data center.

### Example 7

The method according to Examples 1-6 wherein the online service comprises at least one of a productivity application service, an email service, a unified communication service, a chat service, a voice calling service, an online video service, a gaming service, a media service, a document storage service, and a web service.

### Example 8

An apparatus comprising one or more computer readable storage media and program instructions stored on the one or more computer readable storage media for upgrading service applications deployed in data centers that, when executed by a processing system in a data center, direct the processing system to at least: receive a delta file comprising a difference between a new version of a service application and a previous version of the service application; remove an instance of the service application installed in the data center out of service temporarily to update the instance of the service application from the previous version of the service application to the new version of the service application; initiate an update of the instance of the service application to the new version of the service application using at least the delta file; and return the instance of the service application to service upon completing the update to the new version of the service application.

### Example 9

the apparatus according to Example 8 wherein the data center comprises a plurality of service platforms having a plurality of instances of the service application installed thereon to provide an online service to a plurality of client applications in remote communication with the plurality of instances of the service application.

### Example 10

the apparatus according to Examples 8-9 further comprising additional program instructions that, when executed by an additional processing system in the development environment, direct the additional processing system to communicate the delta file from the development environment to the data center for a plurality of update agents to update the plurality of instances of the service application.

### Example 11

the apparatus according to Examples 8-10 wherein to communicate the delta file from the development environment to the data center, the additional program instructions direct the additional processing system to communicate the delta file to each update agent of a plurality of update agents on an individual basis.

### Example 12

the apparatus according to Examples 8-11 wherein to communicate the delta file from the development environment to the data center, the additional program instructions direct the additional processing system to communicate the delta file to a staging service in the data center for distribution to each update agent of the plurality of update agents.

### Example 13

the apparatus according to Examples 8-12 wherein the development environment comprises a plurality of development platforms for developing the new version of the service application, producing the delta file, and communicating the delta file to the data center.

### Example 14

the apparatus according to Examples 8-13 further comprising the processing system configured to execute the program instructions, wherein the online service comprises at least one of a productivity application service, an email service, a unified communication service, a chat service, a voice calling service, an online video service, a gaming service, a media service, a document storage service, and a web service.

### Example 15

a method for upgrading a plurality of instances of a service application deployed in a data center to provide an online service, the method comprising: in a development environment, producing at least a delta file comprising a difference between a new version of the service application and a previous version of the service application; communicating the delta file from the development environment to a service environment having a plurality of instances of the service application installed therein; and in the service environment, upgrading the plurality of instances of the service application from the prior version of the service application to the new version of the service application using the delta file.

### Example 16

the method of Example 15 wherein upgrading the plurality of instances of the service application comprises removing each instance of the plurality of instances of the service application from service prior to upgrading the instance and returning the instance to service after upgrading the instance.

### Example 17

the method of Examples 15-16 wherein communicating the delta file from the development environment to the service environment comprises communicating the delta file on a per-instance basis directly to each of the plurality of instances of the service application.

### Example 18

the method of Examples 15-17 wherein communicating the delta file from the development environment to the service environment comprises communicating the delta file to a storage service in the development environment and distributing the delta file on a per-instance basis from the storage service to each of the plurality of instances of the service application.

### Example 19

the method of Examples 15-18 wherein distributing the delta file comprises, in each of a plurality of update agents corresponding to each of the plurality of instances of the service application, retrieving the delta file from the storage service at a time specified by an update profile for each of the plurality of instances of the service application.

### Example 20

the method of Examples 15-19 wherein the online service comprises at least one of a productivity application service, an email service, a unified communication service, a chat service, a voice calling service, an online video service, a gaming service, a media service, a document storage service, and a web service.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method for upgrading service applications deployed in data centers, the method comprising:
in a data center, receiving a delta file comprising a difference between a new version of a service application and a previous version of the service application;
removing an instance of the service application installed in the data center out of service temporarily to update the instance of the service application from the previous version of the service application to the new version of the service application;
initiating an update of the instance of the service application to the new version of the service application using at least the delta file; and
returning the instance of the service application to service upon completing the update to the new version of the service application.

2. The method of claim 1 wherein the data center comprises a plurality of service platforms having a plurality of instances of the service application installed thereon to provide an online service to a plurality of client applications in remote communication with the plurality of instances of the service application.

3. The method of claim 2 further comprising producing the delta file in a development environment and communicating the delta file from the development environment to the data center for a plurality of update agents to update the plurality of instances of the service application.

4. The method of claim 3 wherein communicating the delta file from the development environment to the data center comprises communicating the delta file to each update agent of a plurality of update agents on an individual basis.

5. The method of claim 3 wherein communicating the delta file from the development environment to the data center comprises communicating the delta file to a staging service in the data center for distribution to each update agent of the plurality of update agents.

6. The method of claim 3 wherein the development environment comprises a plurality of development platforms for developing the new version of the service application, producing the delta file, and communicating the delta file to the data center.

7. The method of claim 3 wherein the online service comprises at least one of a productivity application service, an email service, a unified communication service, a chat service, a voice calling service, an online video service, a gaming service, a media service, a document storage service, and a web service.

8. An apparatus comprising:
one or more computer readable storage media; and
program instructions stored on the one or more computer readable storage media for upgrading service applications deployed in data centers that, when executed by a processing system in a data center, direct the processing system to at least:
receive a delta file comprising a difference between a new version of a service application and a previous version of the service application;
remove an instance of the service application installed in the data center out of service temporarily to update the instance of the service application from the previous version of the service application to the new version of the service application;
initiate an update of the instance of the service application to the new version of the service application using at least the delta file; and
return the instance of the service application to service upon completing the update to the new version of the service application.

9. The apparatus of claim 8 wherein the data center comprises a plurality of service platforms having a plurality of instances of the service application installed thereon to provide an online service to a plurality of client applications in remote communication with the plurality of instances of the service application.

10. The apparatus of claim 9 further comprising additional program instructions that, when executed by an additional processing system in a development environment, direct the additional processing system to communicate the delta file from the development environment to the data center for a plurality of update agents to update the plurality of instances of the service application.

11. The apparatus of claim 10 wherein to communicate the delta file from the development environment to the data center, the additional program instructions direct the additional processing system to communicate the delta file to each update agent of a plurality of update agents on an individual basis.

12. The apparatus of claim 10 wherein to communicate the delta file from the development environment to the data center, the additional program instructions direct the additional processing system to communicate the delta file to a staging service in the data center for distribution to each update agent of the plurality of update agents.

13. The apparatus of claim 10 wherein the development environment comprises a plurality of development platforms for developing the new version of the service application, producing the delta file, and communicating the delta file to the data center.

14. The apparatus of claim 10 further comprising the processing system configured to execute the program instructions, wherein the online service comprises at least one of a productivity application service, an email service, a unified communication service, a chat service, a voice calling service, an online video service, a gaming service, a media service, a document storage service, and a web service.

15. A method for upgrading a plurality of instances of a service application deployed in a data center to provide an online service, the method comprising:
in a development environment, producing at least a delta file comprising a difference between a new version of the service application and a previous version of the service application;
communicating the delta file from the development environment to a service environment having a plurality of instances of the service application installed therein; and
in the service environment, upgrading the plurality of instances of the service application from the previous version of the service application to the new version of the service application using the delta file.

16. The method of claim 15 wherein upgrading the plurality of instances of the service application comprises removing each instance of the plurality of instances of the service application from service prior to upgrading the instance and returning the instance to service after upgrading the instance.

17. The method of claim 16 wherein communicating the delta file from the development environment to the service environment comprises communicating the delta file on a per-instance basis directly to each of the plurality of instances of the service application.

18. The method of claim 16 wherein communicating the delta file from the development environment to the service environment comprises communicating the delta file to a storage service in the development environment and distributing the delta file on a per-instance basis from the storage service to each of the plurality of instances of the service application.

19. The method of claim 18 wherein distributing the delta file comprises, in each of a plurality of update agents corresponding to each of the plurality of instances of the service application, retrieving the delta file from the storage service at a time specified by an update profile for each of the plurality of instances of the service application.

20. The method of claim 15 wherein the online service comprises at least one of a productivity application service, an email service, a unified communication service, a chat service, a voice calling service, an online video service, a gaming service, a media service, a document storage service, and a web service.
